(19) United States
(12) Patent Application Publication
(10) Pub. No.: US 2024/0024901 A1
(43) Pub. Date: Jan. 25, 2024

(54) SPRAYING ELEMENT, IN PARTICULAR BELL, AND ASSOCIATED OPERATING METHOD

(71) Applicant: Dürr Systems AG, Bietigheim-Bissingen (DE)

(72) Inventors: Bernhard Seiz, Lauffen (DE); Michael Baumann, Flein (DE); Harry Krumma, Bönnigheim (DE); Frank Herre, Oberriexingen (DE); Hans-Jürgen Nolte, Besigheim (DE); Christoph Heckeler, Renningen (DE); Andreas Bushbeck, Bickenbach (DE)

(21) Appl. No.: 18/255,188

(22) PCT Filed: Dec. 14, 2021
(86) PCT No.: PCT/EP2021/085576

§ 371 Date: May 31, 2023

(30) Foreign Application Priority Data
Dec. 18, 2020 (DE) 10 2020 134 121.0

(51) Int. Cl. B05B 3/10

(52) U.S. Cl. CPC B05B 3/1014

(57) ABSTRACT

The disclosure relates to a spray-off body, in particular a bell cup, for a rotary atomizer for applying a coating agent to a component, in particular for applying a paint to a motor vehicle body component. The spray-off body according to the disclosure is characterized by at least one balancing mass for the automatic passive balancing of the spray-off body, the balancing mass being movably arranged in the spray-off body in order to enable the automatic passive balancing of the spray-off body in a supercritical speed range.

### CROSS-REFERENCE TO RELATED APPLICATIONS

This application is a national stage of, and claims priority to, Patent Cooperation Treaty Application No. PCT/EP2021/085576, filed on Dec. 14, 2021, which application claims priority to German Application No. DE 10 2020 134 121.0, filed on Dec. 18, 2020, which applications are hereby incorporated herein by reference in their entireties.

### FIELD

The disclosure relates to a spray-off body, in particular a bell cup or a spray disc, for a rotary atomizer for applying a coating agent to a component, in particular for applying a paint to a motor vehicle body component. Furthermore, the disclosure relates to a rotary atomizer with such a spray-off body, a painting robot with such a rotary atomizer and a coating system with one of these components (spray-off body, rotary atomizer, coating robot). Furthermore, the disclosure also relates to a corresponding operating method.

### BACKGROUND

In modern painting installations for painting motor vehicle body components, rotary atomizers, which rotate a bell cup at high speed during painting operation, are usually used as application device. The paint to be applied is fed to the rotating bell cup via a central paint nozzle and then flows at the end of the rotating bell cup via an overflow surface to an annular spray-off edge where the paint is sprayed off. Due to the high rotational speeds of the bell cup, it is important that the bell cup has as little imbalance as possible. It is therefore known from the prior art to balance the bell cups before delivery. For this purpose, balancing holes, press profiles or grinding marks can be made in the bell cup in order to balance the bell cup. However, this known method of active balancing of bell cups is associated with various disadvantages.

On the one hand, the production of bell cups with a very low residual unbalance is expensive, since precise manufacturing is required and active balancing is costly.

Secondly, it is not possible to balance the bell cups during operation. This is problematic because bell cups acquire an unbalance during painting operation, for example due to damage or contamination with the applied paint. These imbalances acquired during painting operation cannot be eliminated, so that it is usually necessary to replace the bell cup if the imbalance exceeds a permissible level.

This is also problematic because the unbalance of the bell cup acquired in normal painting operation can lead to undesirable operating vibrations and to a high operating load, up to and including failure of the rotary atomizer. Such a mechanical load on the rotary atomizer in painting operation due to an acquired imbalance is often only detected when the rotary atomizer has already failed, for example due to a blockage of the turbine that drives the rotary atomizer. Such a turbine blockage can lead to consequential faults, such as grinding, in extreme cases with sparking, or detachment of the bell cup from the rotary atomizer with fire and explosion hazards.

For the technical background of the disclosure, reference should also be made to DE 10 2010 013 551 B4.

Finally, DE 35 08 970 C1 discloses the principle of independent passive balancing in a rotary atomizer. Here, the balancing mass required for independent passive balancing is not arranged in the spray-off body, but in a separate annular body, which has proven to be impractical.

### BRIEF DESCRIPTION OF THE DRAWINGS

FIG. 1 shows a cross-sectional view through a bell cup according to the disclosure with balancing masses for automatic passive balancing.

FIG. 2 shows a schematic representation of a painting system according to the disclosure.

FIG. 3 shows a flow diagram to illustrate the operating method according to the disclosure.

FIG. 4 shows a diagram to illustrate the automatic passive balancing at the start of a coating process.

FIG. 5 shows a variation of FIG. 4 with a coating operation in the supercritical speed range.

### DETAILED DESCRIPTION

With regard to the disclosure, it should first be noted that the principle according to the disclosure is generally suitable for balancing the spray-off bodies of rotary atomizers. The disclosure is therefore not limited to bell cups with regard to the type of spray-off body, but can also be used, for example, with spray discs of disc atomizers.

Furthermore, it should be mentioned that the disclosure is not limited to paints with regard to the type of coating agent to be applied. Rather, the principle according to the disclosure can also be used with rotary atomizers that apply other types of coating agents.

Furthermore, it should also be mentioned that the disclosure is not limited to motor vehicle body components with respect to coated components. Rather, the principle according to the disclosure can also be used in the coating of other types of components.

The disclosure is based on the general technical realization that balancing of spray-off bodies rotating in operation is not only possible—as described at the beginning—actively, for example by introducing balancing holes into the spray-off body. Rather, the disclosure comprises the general technical realization that spray-off bodies rotating in operation can also be balanced passively by themselves, as is known per se from the prior art. For this purpose, it is necessary to provide a balancing mass in the spray-off body, which can move freely in the spray-off body in the circumferential direction. If the spray-off body is now accelerated to a supercritical speed, the balancing mass moves automatically in such a way that the spray-off body is balanced. The critical speed in this sense is the speed of the bearing system in which resonance effects occur.

The term balancing used in the context of the disclosure does not require that the spray-off body is perfectly balanced after balancing and no longer exhibits any unbalance. Rather, in the context of the disclosure, this term also includes a reduction of the unbalance of the spray-off body so that the spray-off body still has a small remaining unbalance after balancing.

The above-mentioned technique of independent passive balancing of rotating bodies is in itself known from the prior art, as has already been briefly mentioned above. For example, reference should be made here to the following publications:
Makram, M. et al: “Effect of Automatic ball balancer on unbalanced rotor vibration”, 17th International Conference on AEROSPACE SCIENCES & AVIATION TECHNOLOGY, Apr. 11-13, 2017.
Kim, T., Na, S.: “New automatic ball balancer design to reduce transient-response in rotor system”, Mechanical Systems and Signal Processing, 2013, Vol. 37, pages 265-275.
Green K, Champneys A. R, Friswell M. I and Muñoz A. M, 2008, “Investigation of a multi-ball, automatic dynamic balancing mechanism for eccentric rotors”, Phil. Trans. R. Soc. A.366705-728.
Adolfsson, J.: “Passive Control of Mechanical Systems Bipedal Walking and Autobalancing,” ISSN 0348-467X.
B. Hredzak and Guoxiao Guo, “Adjustable balancer with electromagnetic release of balancing members,” in IEEE Transactions on Magnetics, vol. 42, no. 5, pp. 1591-1596, May 2006, doi: 10.1109/TMAG.2005.863619.
Hwang, C., Chung, J.: “Dynamic analysis of an automatic ball balancer with two races,” JSME International Journal, 1999, Series C, vol. 42, no. 2. pp. 265-272.
U.S. Pat. No. 8,286,453 B2.

Up to now, however, the technique of automatic passive balancing with a movable balancing mass has not yet been used for balancing the spray-off bodies (e.g. bell cups) of rotary atomizers, since there was a prejudice among experts that the specific conditions (e.g. speed, torque, etc.) of rotary atomizers do not permit automatic passive balancing.

The spray-off body according to the disclosure comprises at least one balancing mass for automatic passive balancing of the spray-off body, the balancing mass being arranged movably in the spray-off body.

In addition, the spray-off body according to the disclosure preferably has at least one annularly circumferential receiving chamber in the spray-off body for movably receiving the balancing mass therein. For example, this receiving chamber can be formed as an annular groove or as an annular circumferential cavity. It should be mentioned here that the balancing mass can be designed as a UV-curable resin, as will be described in detail. In this case, it is useful if the receiving chamber for the UV-curable resin serving as the balancing mass can be viewed from the outside, so that the UV-curable resin can be cured by UV irradiation from the outside.

Furthermore, within the scope of the disclosure, it is possible for the spray-off body to have several receiving chambers for a corresponding number of balancing masses. The individual receiving chambers can each be formed as an annular groove or as an annular circumferential cavity, as already briefly described above.

It should be mentioned here that the individual receiving chambers can optionally be separated from one another or connected to one another.

It should also be mentioned that the receiving chambers can be arranged axially and/or radially offset from one another.

In the course of the automatic passive balancing of the spray-off body, the balancing mass can move freely in the spray-off body. The receiving chamber in the spray-off body is preferably designed in such a way that the balancing mass can move along a predetermined path, which can run, for example, in the circumferential direction (tangentially), radially and/or axially. An axial course of the path for the movement of the compensation mass means here that the path runs parallel to the axis of rotation of the spray-off body. A radial course of the path for the movement of the compensation mass, on the other hand, means that the path runs radially with respect to the axis of rotation of the spray-off body. Finally, a tangential course of the path for the movement of the balancing mass means that the path runs in the circumferential direction with respect to the axis of rotation of the spray-off body. The path for the movement of the balancing mass can also have several path sections which are oriented differently, for example radially, axially or tangentially depending on the path section.

With regard to the balancing mass itself, various possibilities exist within the scope of the disclosure.

For example, the balancing mass may be a fluid, such as a liquid (e.g., water or oil).

However, it is also possible that the fluid is a resin, such as the UV-curable resin described briefly above. Irradiation of the UV-curable resin with UV light then enables the UV-curable resin to be fixed in the balanced state of the spray-off body.

Alternatively, the balancing mass may be a powder or granules of numerous solid particles (e.g., spheres).

In another alternative, the balancing mass is a mixture of solid particles (e.g. spheres) in a fluid (e.g. oil or water). In this case, it is useful if the combination of the solid particles with the fluid is adjusted so that the particles can only move in the fluid in the supercritical speed range.

Furthermore, within the scope of the disclosure, it is also possible for the balancing mass to be a wax.

It has already been briefly mentioned above that the balancing mass moves freely in the spray-off body during the automatic passive balancing. In the supercritical speed range during automatic passive balancing, free movement of the balancing mass in the spray-off body is thus desirable. In the supercritical speed range, the unbalance and the deflection of the balancing mass show an opposite phase. As a result, the balancing mass aligns itself against the angular position of the unbalance (i.e. in phase opposition) and thus automatically compensates for the unbalance. When the spray-off body is operated in the subcritical speed range, on the other hand, the unbalance and the deflection of the balancing mass show the same phase position. As a result, the balancing mass is arranged in the angular position of the unbalance (i.e. in phase) and further amplifies the existing unbalance. In the supercritical speed range, free movement of the balancing mass is thus desirable, while the mobility of the balancing mass in the subcritical speed range is disturbing.

In one variant of the disclosure, it is therefore provided that the fluid of the balancing mass has a viscosity which is dependent on at least one of the following influencing variables:
Temperature of the fluid of the balancing mass,
magnetic field acting on the fluid
electric field acting on the fluid, and/or
mechanical stress on the fluid, in particular due to the shear rate of the fluid.

This makes it possible to specifically influence the mobility of the fluid serving as the balancing mass in the spray-off body by changing the aforementioned influencing variables.

For example, the fluid serving as the balancing mass can therefore be a non-Newtonian fluid, such as a Casson fluid, a Bingham fluid or a Boger fluid, to name just a few examples.

In general, it should also be mentioned that the balancing mass should be sufficiently large to allow the automatic passive balancing of the spray-off body given the spatial location of the balancing mass within the spray-off body.

In accordance with the prior art, the spray-off body according to the disclosure (e.g., bell cup) is structurally designed for a certain operating speed range, whereby the spray-off body then rotates at an operating speed within the operating speed range during the application of the coating agent in the coating operation. Furthermore, it should be mentioned that the bearing system has a critical speed due to its design, at which the bearing system exhibits resonance effects. The bearing system therefore has a subcritical speed range with speeds below the critical speed and a supercritical range with speeds above the critical speed.

In one variant of the disclosure, the critical speed is below the operating speed range, so that the actual coating operation takes place in the supercritical speed range. In this disclosure variant, the automatic passive balancing therefore also takes place in the normal coating operation.

In another disclosure variant, however, the critical speed is above the operating speed range of the spray-off body, so that the coating operation takes place in the subcritical speed range. This has the consequence that no automatic passive balancing takes place in the normal coating operation. For automatic passive balancing of the spray-off body, the spray-off body must then be accelerated from the subcritical speed range into the supercritical speed range.

When the spray-off body is operated in the subcritical speed range, it makes sense for the balancing mass not to be movable, since the balancing mass would then reinforce an existing imbalance, as has already been briefly mentioned above. It is therefore useful if the balancing mass can be fixed in the subcritical speed range to prevent this undesirable amplification of the existing unbalance. The spray-off body can therefore have a fixing mechanism that can fix the balancing mass partially or completely in the spray-off body. This is particularly useful if the spray-off body passes through the subcritical speed range during startup in order to reach the supercritical speed range. Furthermore, fixing the balancing mass is also useful after automatic passive balancing in the supercritical speed range, so that the balancing mass then maintains its balanced position during subsequent coating operation in the subcritical speed range.

This fixing mechanism can, for example, be integrated into the spray-off body. However, it is also possible for the fixing mechanism to be separate from the spray-off body and located in the rotary atomizer. Finally, it is also possible that the fixing mechanism is completely separate from the spray-off body and also from the rotary atomizer.

Preferably, the fixation mechanism is designed to release the balancing mass above the critical speed, so that the balancing mass can then move in the spray-off body to enable the automatic passive balancing of the spray-off body.

Furthermore, the fixing mechanism is preferably designed in such a way that the balancing mass is fixed below the critical speed so that the balancing mass then cannot move or can only move to a reduced extent in the spray-off body in order to prevent amplification of the resonances by the balancing mass.

For example, the fixing mechanism may comprise a spring-mass system. However, it is also possible that the fixing mechanism comprises an electromagnet, which is arranged in the spray-off body or in the rotary atomizer and fixes the balancing mass in the activated state.

Furthermore, within the scope of the disclosure, it is possible that the balancing mass consists of a fluid that is magneto-rheological or electro-rheological. This means that the viscosity of the fluid de-pends on a magnetic field or an electric field acting on the fluid. This also makes it possible to influence the mobility of the balancing mass in the spray-off body in the manner described above.

Finally, the disclosure also comprises a corresponding operating method for a spray-off body according to the disclosure. Within the scope of the operating method according to the disclosure, it is provided that the spray-off body is operated at a rotational speed in the supercritical rotational speed range, so that the movable balancing mass in the spray-off body leads to an automatic passive balancing of the spray-off body.

In one variant of the disclosure, the self-acting passive balancing of the spray-off body takes place on the rotary atomizer, i.e. while the spray-off body is mounted on the rotary atomizer.

In another variant of the disclosure, however, the automatic passive balancing of the spray-off body takes place on a balancing machine, i.e. while the spray-off body is separated from the rotary atomizer.

In this case, the coating operation preferably takes place in the subcritical speed range, so that the spray-off body must be accelerated into the supercritical speed range for automatic passive balancing.

However, it is also possible that the coating operation takes place in the supercritical speed range, so that the automatic passive balancing takes place during the coating operation.

When passing through the subcritical speed range during acceleration into the supercritical speed range, the balancing mass is preferably fixed while passing through the subcritical speed range. After reaching the supercritical speed range, the balancing mass is then preferably released in the spray-off body so that the spray-off body can automatically balance passively. The balancing mass is then preferably fixed again and the spray-off body is braked back to the subcritical speed range, where the actual coating operation then takes place.

The operating method according to the disclosure therefore preferably also provides for fixing of the balancing mass in the spray-off body, in particular when passing through the subcritical speed range into the supercritical speed range or after the automatic passive balancing of the spray-off body. The balancing mass can be fixed, for example, by UV irradiation of the UV-curable balancing mass, by heating the balancing mass or by applying a magnetic field or an electric field to the balancing mass, as described briefly above.

Furthermore, the operating method according to the disclosure preferably provides for automatic passive balancing to take place regularly, for example in each case after a predetermined period of time has elapsed (e.g. once a day), after a predetermined coating period has elapsed or after a predetermined number of revolutions of the spray-off body. In general, automatic passive balancing can be performed whenever a corresponding demand message is received from a monitoring device.

Other advantageous further embodiments of the disclosure are indicated in the dependent claims or are explained in more detail below together with the description of the preferred embodiments of the disclosure with reference to the figures.

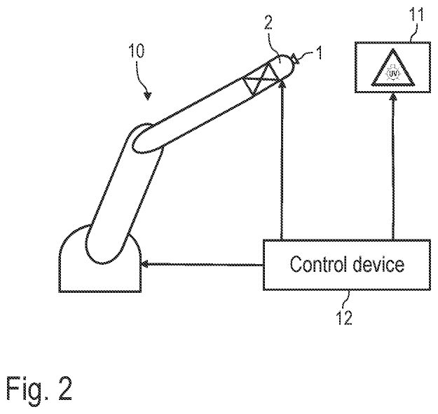

In the following, the embodiment of a bell cup 1 according to the disclosure, which can be mounted on a rotary atomizer 2 as schematically shown in FIG. 2, is described. The bell cup 1 has a largely conventional design and is therefore described only briefly below. Thus, in operation, the bell cup 1 rotates about a rotation axis 3 and can be screwed onto a turbine shaft (not shown) of the rotary atomizer 2. However, the bell cup 1 can also be attached to the turbine shaft in a different way, which is known in itself from the prior art. In this case, the paint to be applied is fed centrally through a paint nozzle and then first hits the rear side of a distributor disc 4 in the axial direction, which deflects a large part of the paint radially outward onto an overflow surface 5 of the bell cup 1. The paint then flows outward along the overflow surface 5 to an annular spray-off edge 6, where the paint is sprayed off. In addition, the bell cup 1 also has an outer lateral surface 7 which can be rinsed and thus cleaned by external rinsing channels, but this is not essential to the disclosure.

The bell cup 1 according to the disclosure is now characterized by several annularly circumferential receiving chambers 8, in each of which a balancing mass 9 is arranged. The receiving chambers 8 are arranged offset from one another in the radial direction and in the axial direction. In addition, it should be mentioned that the receiving chambers 8 are arranged in an annular circumferential manner so that the balancing mass 9 can move freely in the receiving chambers 8 in the circumferential direction.

Alternatively, it is also possible that there is only a single receiving chamber 8 with only a single balancing mass 9. Furthermore, there is also the possibility that the receiving chambers 8 are formed as annular grooves that are accessible from the outside, which allows the balancing mass to be cured by UV irradiation.

When the bell cup 1 is accelerated into a supercritical speed range, the free movement of the balancing masses 9 in the receiving chambers 8 then leads to the desired automatic passive balancing of the bell cup. This means that the balancing masses 8 are arranged in phase opposition to the existing imbalances and thus compensate for them.

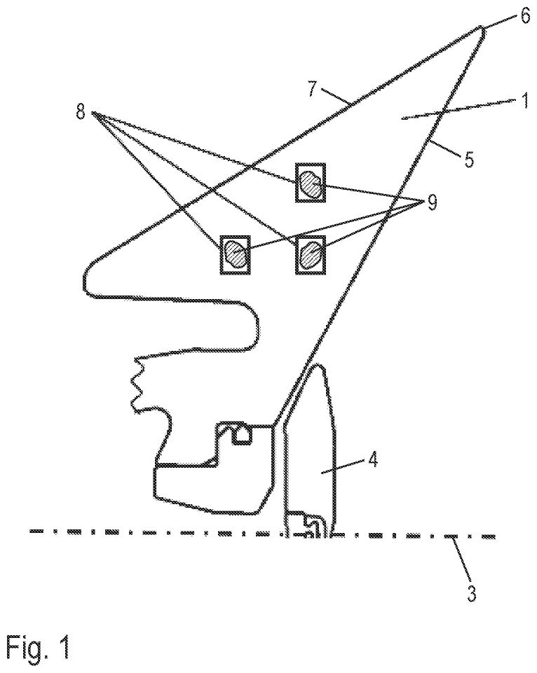

FIG. 2 shows a highly simplified schematic representation of a painting installation according to the disclosure with the bell cup 1 and the rotary atomizer 2, which is guided by a multi-axis painting robot 10. It should be mentioned here that, in deviation from the illustration in FIG. 1, the balancing masses 9 in the receiving chambers 8 are arranged in such a way that the balancing masses 9 can be seen from the outside, for example in an annular groove. Furthermore, it should be mentioned that the balancing mass 9 here are a UV-curable resin that can be cured by irradiation with a UV irradiation device 11.

In addition, the drawing shows a control device 12 which controls the operation of the painting installation.

For passive self-balancing, the control device 12 first controls the rotary atomizer 2 so that the bell cup 1 is accelerated into a supercritical speed range. In doing so, the mobility of the balancing masses 9 then resulted in the desired self-acting passive balancing. Subsequently, the bell cup 1 is then irradiated with UV light by the UV irradiation device 11 to cure the UV curable resin serving as the balancing mass, so that the balancing mass 9 then remains in the balanced state later.

The control device 12 can then brake the rotary atomizer 2 back to the non-critical speed range in which the actual painting operation takes place.

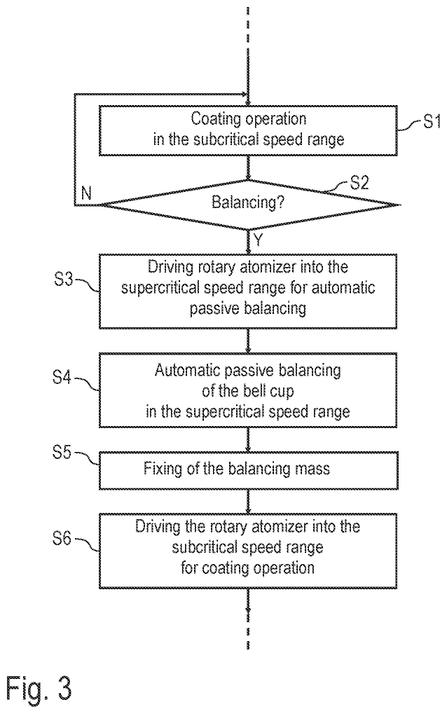

FIG. 3 shows a flow diagram to illustrate the operating method according to the disclosure.

In a step S1, coating operation takes place in the subcritical speed range, as is known per se from the prior art.

In a step S2 it is then continuously checked whether balancing is required. For example, this may be the case once a day as a function of time.

If this is not the case, the coating operation is continued in the subcritical speed range in step S1.

If, on the other hand, balancing is required, the process moves to step S3, in which the rotary atomizer is accelerated into the supercritical speed range.

In the supercritical speed range, the desired automatic passive balancing of the bell cup then takes place in step S4.

The balancing mass is then fixed in step S5.

After fixing the balancing mass, the actual coating operation can then take place again in the subcritical speed range according to step S6.

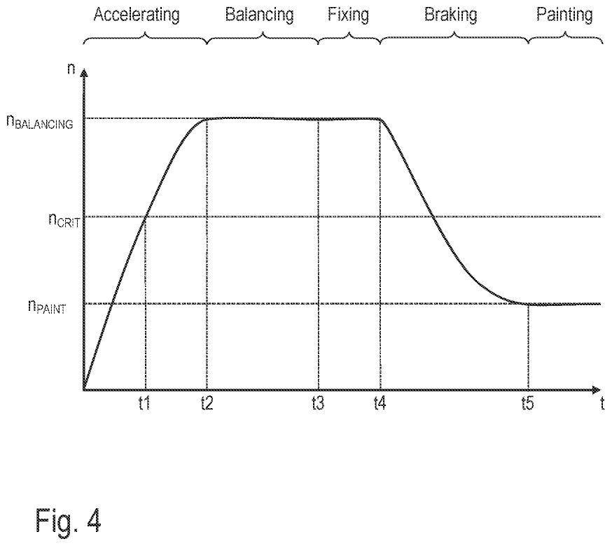

FIG. 4 shows a diagram to illustrate the various operating phases when starting the rotary atomizer.

It should be noted in advance that this diagram does not show a scale representation, but is only intended to qualitatively delimit the various operating phases relative to one another.

From time t=0 to t=t2, the rotary atomizer is accelerated to a speed n_{BALANCING}, which is above the critical speed n_{CRIT} and is intended to enable automatic passive balancing of the bell cup.

In the operating phase from t=t2 to t=t3, the automatic passive balancing of the bell cup then takes place.

In the next operating phase from t=t3 to t=t4, the balancing mass is then fixed in the balanced state, for example by UV irradiation of the UV-curable balancing mass.

Subsequently, in the operating phase from t=t4 to t=t5, the rotary atomizer is braked back to a subcritical speed n_{PAINT}, and in the operating phase from t=t5 onward, normal coating operation is then resumed at the subcritical speed n_{PAINT}.

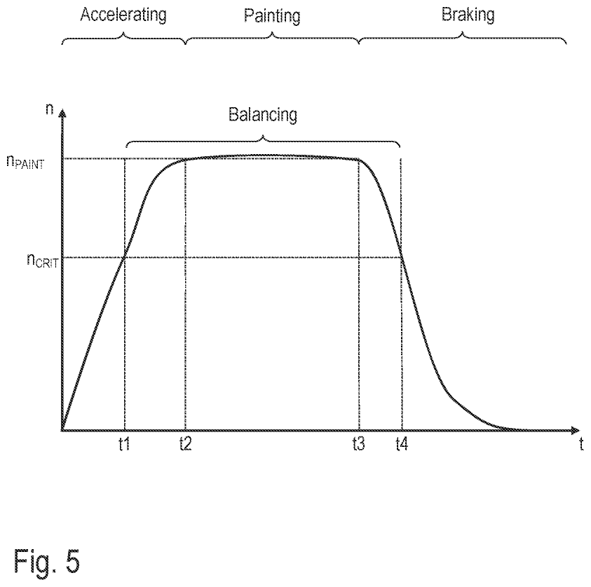

FIG. 5 shows a variation of FIG. 4.

Here, the painting operation takes place in the supercritical speed range between t=t2 and t=t3. This means that the automatic passive balancing of the spray-off body in the supercritical speed range from t=t1 to t=t4 also includes the painting operation.

1.-22. (canceled)

23. A spray-off body for a rotary atomizer for applying a coating agent to a component, comprising at least one balancing mass for an automatic passive balancing of the spray-off body, the balancing mass being movably arranged in the spray-off body in order to enable the automatic passive balancing of the spray-off body in a supercritical speed range.

24. The spray-off body, wherein the spray-off body is a bell cup.

25. The spray-off body according to claim 24, further comprising at least one annularly circumferential receiving chamber in the spray-off body for receiving the balancing mass.

26. The spray-off body according to claim 25, wherein the receiving chamber is an annular groove.

27. The spray-off body according to claim 25, wherein the receiving chamber is an annularly circumferential cavity.

28. The spray-off body according to claim 25, wherein the spray-off body has a plurality of receiving chambers for the balancing mass.

29. The spray-off body according to claim 28, wherein the receiving chambers are separated from one another.

30. The spray-off body according to claim 28, wherein the receiving chambers are connected to each other.

31. Spray-off body according to claim 28, wherein the receiving chambers are axially offset from one another.

32. The spray-off body according to claim 28, wherein the receiving chambers are radially offset from one another.

33. The spray-off body according to claim 24, wherein the balancing mass can move in the spray-off body along a predetermined path.

34. The spray-off body according to claim 33, wherein the a predetermined path runs in circumferential direction.

35. The spray-off body according to claim 33, wherein the a predetermined path runs radially.

36. The spray-off body according to claim 33, wherein the a predetermined path runs axially.

37. The spray-off body according to claim 24, wherein the balancing mass is selected from a group consisting of:
a) a fluid,
b) a liquid,
c) water,
d) oil,
e) a resin,
f) a UV-curable resin for fixing the resin in the spray-off body by UV irradiation,
g) a powder,
h) granules consisting of numerous solid particles,
i) as a mixture of solid particles in a fluid,
j) a wax.

38. The spray-off body according to claim 37, wherein the fluid of the balancing mass has a viscosity which is dependent on at least one of the following influencing variables:
a) temperature of the fluid,
b) magnetic field acting on the fluid,
c) electric field acting on the fluid, or
d) mechanical load on the fluid.

39. The spray-off body according to claim 37, wherein the fluid of the balancing mass is a non-Newtonian fluid.

40. The spray-off body according to claim 39, wherein the non-Newtonian fluid is selected from a group consisting of:
a) a Casson fluid,
b) a Bingham fluid, or
c) a Boger fluid.

41. Spray-off body according to claim 24, further comprising
a) a structurally predetermined operating speed range, wherein the spray-off body rotates at an operating speed within the operating speed range during application of the coating agent in coating operation,
b) a design-related critical speed at which the bearing system of the spray-off body starts to resonate,
c) a design-related subcritical speed range with speeds below the critical speed of the bearing system, and
d) the design-related supercritical speed range with speeds above the critical speed of the bearing system,
e) where the critical speed
e1) is below the operating speed range, so that the coating operation takes place in the supercritical speed range and the balancing mass thereby leads to the automatic passive balancing of the spray-off body, or
e2) is above the operating speed range, so that no automatic balancing of the spray-off body takes place in coating operation.

42. The spray-off body according to claim 23, wherein a fixing mechanism is provided for partial or complete fixing of the balancing mass in the spray-off body.

43. The spray-off body according to claim 42, wherein the fixing mechanism is integrated into the spray-off body.

44. The spray-off body according to claim 42, wherein the fixing mechanism releases the balancing mass above the critical number of rotation so that the balancing mass can then move in the spray-off body to enable the automatic passive balancing of the spray-off body.

45. The spray-off body according to claim 42, wherein the fixing mechanism fixes the balancing mass below the critical rotational speed and/or when braking from the supercritical rotational speed range into the noncritical rotational speed range, so that the balancing mass cannot then move in the spray-off body or can only move to a reduced extent in order to prevent an increase in unbalance-induced vibrations by the balancing mass.

46. The spray-off body according to claim 42, wherein the fixing mechanism fixes or releases the balancing mass as a function of the centrifugal force.

47. The spray-off body according to claim 42, wherein the fixing mechanism for fixing the balancing mass comprises a magnet.

48. The spray-off body according to claim 42, wherein the fixing mechanism is operated by compressed air.

49. The spray-off body according to claim 42, wherein the fixing mechanism is operated electrically.

50. The spray-off body according to claim 42, wherein the fixing mechanism is operated hydraulically.

51. The spray-off body according to claim 37, wherein the fluid of the balancing mass is magnet-rheological and an electromagnet generates a magnetic field which acts on the fluid and influences the viscosity of the fluid to more or less fix or release the fluid or particles contained therein, or

52. The spray-off body according to claim 37, wherein the fluid of the balancing mass is electro-rheological and a field generator generates an electric field which acts on the fluid and influences the viscosity of the fluid to fix or release the fluid or particles contained therein to a greater or lesser extent.
